(19) United States
(12) Patent Application Publication
(10) Pub. No.: US 2015/0322982 A1
(43) Pub. Date: Nov. 12, 2015

(54) CYLINDER CLAMP

(71) Applicant: Richard Keith Whittingham, Edmonton (CA)

(72) Inventor: Richard Keith Whittingham, Edmonton (CA)

(21) Appl. No.: 14/275,654

(22) Filed: May 12, 2014

(51) Int. Cl. F16B 2/10

(52) U.S. Cl. CPC F16B 2/10

(57) ABSTRACT

A cylinder clamp, having a base member having parts that together define an opening for receiving a cylinder. A first arm and a second arm are mounted to the base member at respective pivots, the first arm and the second arm being linked so that the arms move together. A stop member is movable between a locked position in which the stop member binds at least the first arm and the base member and an open position in which the stop member is out of binding contact with either or both of the first arm and the base member.

### TECHNICAL FIELD

This document relates to cylinder clamps.

### BACKGROUND

Many industries use cylinders for a variety of purposes. One such industry is the welding industry, which uses cylinders for storing pressurized acetylene and oxygen to provide torch fuel. The pressurized gas comes in a plurality of tall metal cylinders, which must be safely stored until and after use. Such cylinders are often stored in an upright orientation in a shop or other storage area. To keep the cylinders from toppling, the cylinders are secured to a wall or adjacent equipment such as on a cylinder skid or trolley. Some securing methods currently in used include chains and ropes strapped to or around the cylinders. Other methods include mechanical screw devices and other devices that involve a physical step to secure the object after placement in the required location.

### SUMMARY

A cylinder clamp, comprising: a base member having parts that together define an opening for receiving a cylinder; a first arm and a second arm mounted to the base member at respective pivots, the first arm and the second arm being linked so that the arms move together; and a stop member movable between a locked position in which the stop member binds at least the first arm and the base member and an open position in which the stop member is out of binding contact with either or both of the first arm and the base member.

In various embodiments, there may be included any one or more of the following features: The base member is planar. The base member has one or more mounts for connecting to an external working surface. The first arm and second arm do not meet when in the locking position. In the open position the first arm and second arm are spaced sufficiently to allow the entry of the cylinder. In the locked position the first arm and second arm extend more than two hundred seventy degrees around a cylinder receptacle defined by the first and second arms. The stop member comprises a pin extended, in the locked position, through an opening in the first arm and an opening in the base member. The opening in the first arm and the opening in the base member are misaligned in the open position and aligned in the locked position. The stop member is biased to extend into the opening in the base member. The stop member comprises a handle to retract the pin from the locked position. The pin is mounted directly or indirectly on the first arm. The first arm and second arm are linked via a lever, and the lever mounts the pin. For each of the first arm and the second arm, the pivot is located between a jaw portion and a rear extension, in which the first arm and the second arm are linked by cooperating arcuate toothed surfaces on each of the rear extensions. A combination of the cylinder clamp and a cylinder locked in the locked position within the opening. The cylinder contains pressurized gas or liquid. The cylinder is empty or is a cylinder that is used for applications other than the storage of pressurized gas or liquid.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIGS. 1 and 2 are top views, partially in section, illustrating a closing sequence of a cylinder clamp, with the base plate not shown.

FIGS. 3 and 4 are perspective views of FIGS. 1 and 2, respectively, with the base plate shown in FIG. 3 only.

FIG. 5 is a section view taken along the section lines 5-5 in FIG. 2.

FIG. 6 is a perspective view of a second embodiment of a cylinder clamp.

### DETAILED DESCRIPTION

Immaterial modifications may be made to the embodiments described here without departing from what is covered by the claims.

A gas cylinder is a pressure vessel used to store gases at above atmospheric pressure. High pressure gas cylinders are also called bottles. The transportation and storage of high pressure cylinders is regulated by many governments throughout the world. Because the contents are under pressure and are sometimes hazardous, there are special safety regulations for handling gas cylinders. These include chaining bottles to prevent falling and breaking, proper ventilation to prevent injury or death in case of leaks and signage to indicate the potential hazards. Installing and replacing gas cylinders should be done by trained personnel. If a compressed gas cylinder tips over, causing the valve block to be sheared off, the rapid release of high pressure gas may cause the cylinder to be violently accelerated, potentially causing property damage, injury, or death. To prevent this, cylinders are normally secured to a fixed object or transport cart with a strap or chain.

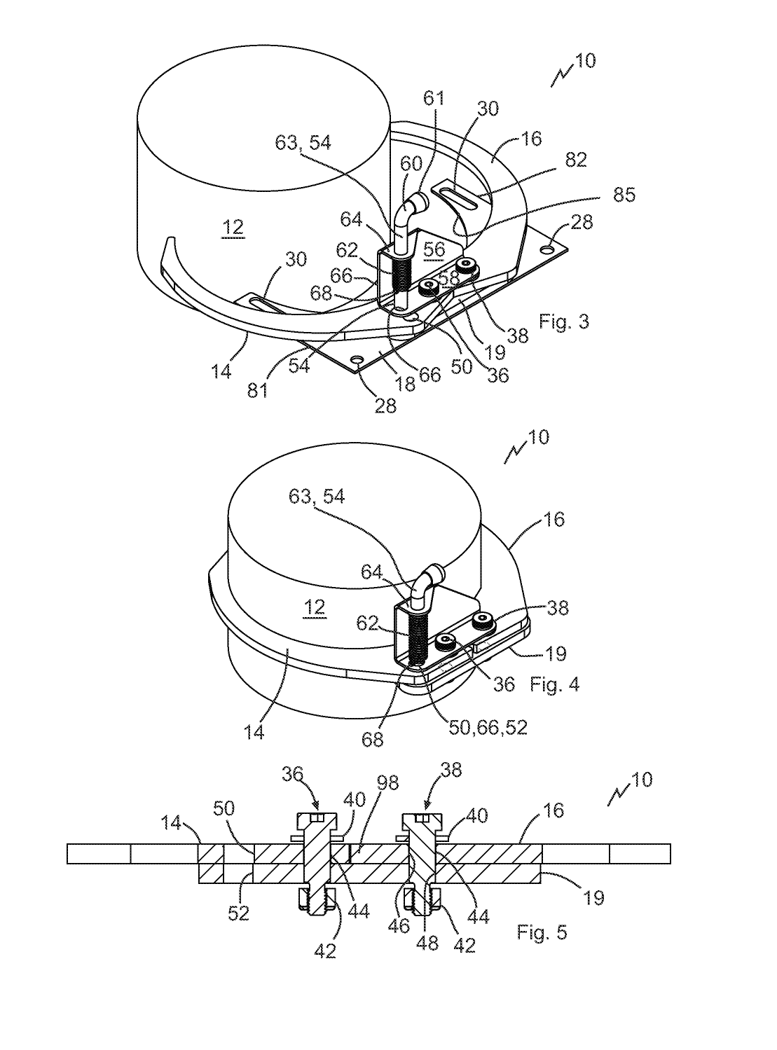

Referring to FIG. 3, a cylinder clamp 10 is illustrated, comprising a base member 18, a first arm 14, a second arm 16, and a stop member 63. The base member 18 has parts that together define an opening 21 (FIG. 1) for receiving a cylinder 12. The parts of the base member 18 include in the example shown a first arm 81, a second arm 82, and an arcuate inner profile 85 corresponding to the curved outer profile of a cylinder 12 (FIG. 3). The base member 18 may be planar, for example, in the base plate form shown, or may at least have a planar under surface (not shown). The base member 18 may have one or more mounts, such as oblong apertures 30 or circular apertures 28, for connecting to an external working surface (not shown). The external working surface may include a ground surface, wall surface, or surface on another piece of equipment such as a clamp connected to the wall or ground, or a trolley, skid, or other movable transportation surface.

Referring to FIG. 1, first arm 14 and second arm 16 may be mounted to the base member 18 at respective pivots, such as bolt posts 36 and 38, respectively. Referring to FIG. 3, the first arm 14 and the second arm 16 may be linked, for example using a lever 58, so that the arms move together. Moving together includes opening and closing together, so that movement by one arm moves the other arm, and vice versa. Similarly, when movement of one arm is impeded, movement of the other arm may be impeded.

Referring to FIGS. 3 and 4, a stop member 63, and the entire cylinder clamp 10, may be movable between a locked position (FIG. 4) and an opened position (FIG. 3). Referring to FIG. 4, in the locked position the stop member 63 binds at least the first arm 14 and the base member 18. In some cases, the stop member 63 is in binding contact with both arms 14 and 16 in the locked position. However, only one arm 14 or 16 need be bound to prevent movement of both arms 14 and 16 since arms 14 and 16 move together. Referring to FIG. 3, in the open position the stop member 63 is out of binding contact with either or both of the first arm 14 and the base member 18.

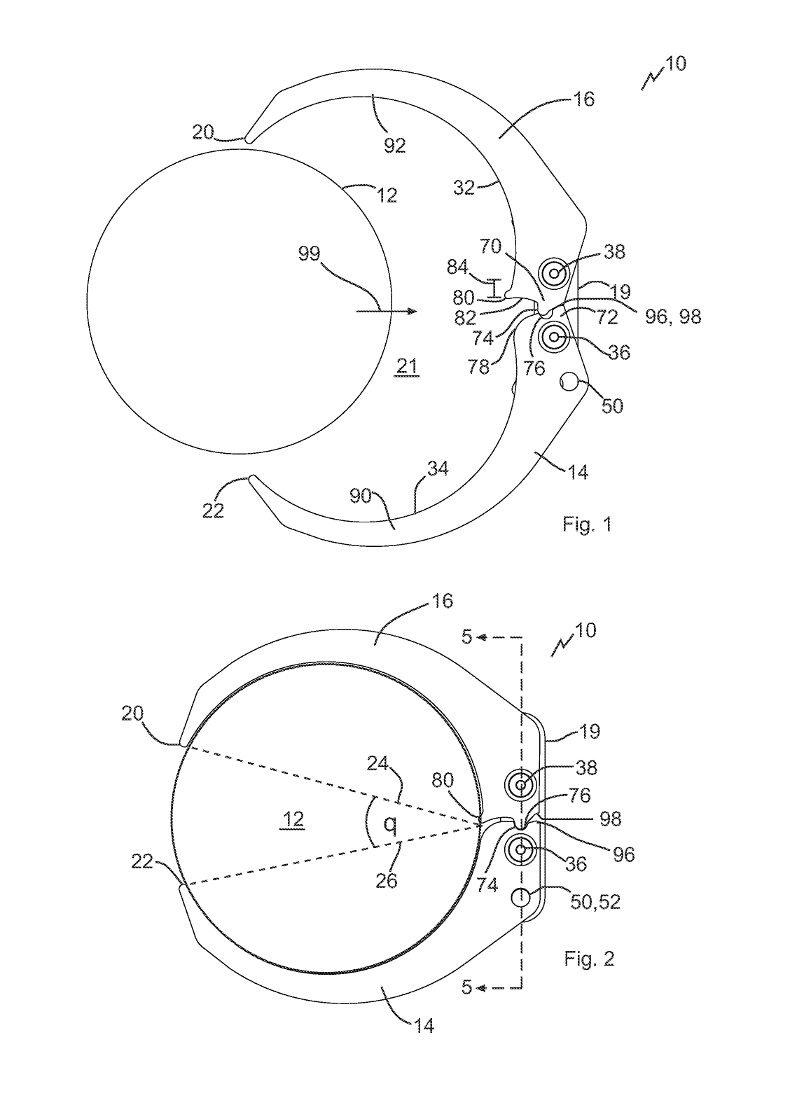

Referring to FIGS. 1, 2, 3, 4 and 5, the stop member 63 may comprise a pin 54. Pin 54 may extend, in the locked position (FIGS. 2 and 4), through an opening 50 in the first arm 14 and an opening 52 in the base member 18. The opening 50 in the first arm 14 and the opening 52 in the base member 18 may be misaligned in the open position (FIGS. 1 and 3) and aligned in the locked position (FIGS. 2 and 4). The pin 54 may be biased, for example by a spring 62, to extend into the opening 52 in the base member 18. The pin 54 may be mounted directly or indirectly (shown) on the first arm 14. For example, indirect mounting is shown because the pin 54 is directly mounted on a holder or bracket 66 that includes lever 58 connected to both pivots 36 and 38. Bracket 66 includes an upstanding wall 56 originating from lever 58 at a ninety degree angle to wall 56, and terminating in a top plate 64 through which pin 54 passes. A spring 62 is compressed in the opened position along a portion of the length of pin 54 between a protrusion, shoulder, or set screw 68 and top plate 64. Thus, as arms 14 and 16 move into the locked position from FIG. 3, as soon as holes 50 and 52 align the spring 62 pushes the pin 54 through holes 50 and 52 to bind further movement. A handle 60 with a hand grip 61 may be present on pin 54 to permit a user to manually retract the pin 54 from the locked position. Upon refraction, the cylinder 12 may be removed from the clamp 10 by imparting a lateral force on the cylinder 12 away from opening 21. Once unlocked the ends FIG. 6 illustrates a second configuration of clamp 10 with a pin bracket 66 that is a mirror image of the pin bracket 66 of FIG. 3.

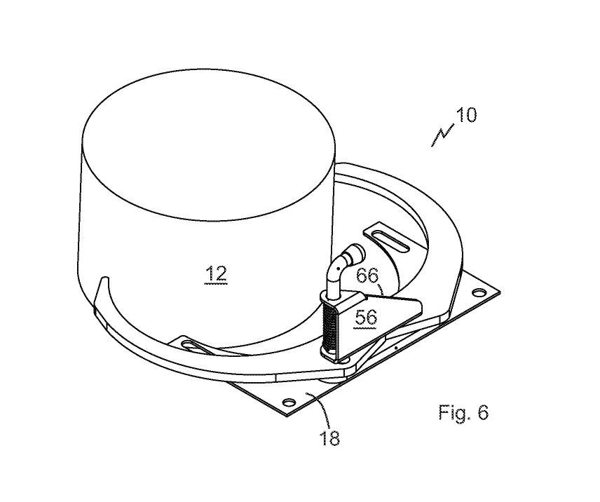

Referring to FIGS. 1, 2, and 5, the arms 14 and 16 may link by a suitable mechanism. For example, for each of the first arm 14 and the second arm 16, the pivot 36 or 38 may be located between a jaw portion 90, 92 and a rear extension 70, 72, respectively (FIG. 1). The first arm 14 and the second arm 16 may be linked by cooperating arcuate toothed surfaces 74 and 76, respectively, on each of the rear extensions 70, 72, respectively. The extensions 70 and 72 are shaped to prevent over-opening past the point shown in FIG. 1, while permitting collective closing to the position shown in FIG. 2. There are several design mechanisms to facilitate such function in the example shown. Firstly, arcuate protrusion 74 of arm 16 meshes like a gear tooth with a corresponding arcuate recess 76 in arm 14. Thus, pivoting movement of one arm is transmitted to the other like a gear. Second, butt portions 96, 98 of extensions 70, 72, respectively, are shaped to extend across cross paths during opening so that butt portions 96 and 98 limit the travel of arms 14 and 16. Butt portions 96 and 98 include matching surfaces that cooperate to stop the arms 14, 16 from overextending by rendering the arms inoperative after a predetermined degree of opening. Referring to FIG. 5, such may be accomplished by having one portion 98 extend past the midpoint between pivots 38 and 40 in an opened position.

Referring to FIGS. 1 and 2, articulating arms 14 and 16 may be designed to close upon contact with a cylinder 12 entering the opening 21. For example, an inward protrusion 80 on an inward facing surface 34 of arm 16 may extend into opening 21 from arm 16. When viewed along an entry axis 99 of cylinder 12, protrusion 80 is spaced a lateral distance 84 from pivot 36. Thus, contact between protrusion 80 and cylinder 12 will transmit torque to arm 16, rotating arm 16. Because protrusion 80 is located on rear extension 72 of arm 16, the torque operates to close the arm 16 over the cylinder. Because arms 14 and 16 are linked to move together, both arms 14 and 16 thus close in unison to at least partially encircle an outer circumference of the cylinder 12 as shown in FIG. 2. A corresponding cutout 78 may be present on an inner surface 34 of arm 14 to avoid interference with protrusion 80 on closing.

The first arm 14 and second arm 16 may not meet when in the locking position (FIG. 2). For example, the first jaw 14 and second jaw 16 may extend more than two hundred seventy degrees around a cylinder receptacle 21 defined by the first and second arms 14, 16, when in the locked position. An exemplary angle of separation is defined between lines 24, 26 drawn from ends 20 and 22 of arms 16 and 14 and meeting at the interface between arms 14 and 16. In other cases ends 20 and 22 may meet when closed, for example, at diametrically opposite positions relative to the interface between arms 14 and 16.

Referring to FIG. 5, pivots 36 and 38 may be formed by suitable mechanisms. For example, bolts 44 are shown, with washers 40 and locking nuts 42 securing the bolts 44 in place. The base member 18 may include a mount plate, such as an inert spacer 19, connected to the base plate or member 18 and mounting the arms 14 and 16 using pivots 36 and 38, respectively. Other pivots may be provided for example with rivets (not shown).

In the open position, the first arm and second arm are spaced sufficiently to allow the entry of the cylinder. In the example, shown the opening 21, when in the locked position, has roughly the same dimensions as the cylinder 12. However, in other cases, the cylinder 12 will be smaller than the closed opening 21. In such cases one or more spacers may be added for example using clips to one or more of the cylinder 12, arm 14, or arm 16 to sufficiently fill the void space that would otherwise be left in the clamp when locked around such a cylinder 12. For example, one or more crescent shaped spacers may be attached around at least part of the circumference of the cylinder or along the inner arcuate surfaces 32 or 34 of the arms 14 or 16. Another way to fit various sizes of cylinders is to use slidable pivots that can lock in various positions as in adjustable pliers.

The cylinder clamp 10, which may also be referred to as a cylinder bracket or bottle clamp, may be used to secure any object with a cylindrical form whether containing pressurized or unpressurized gas, liquids. The cylinder may also be empty. Cylinders include cylindrical vertical standing objects. A cylinder may also be stored, using the clamp 10, in a fixed location. In some cases, non-cylindrical objects may be secured using the clamp 10, including columns, I-beams, building materials, and various containers. In some cases, cylindrical objects that are not intended for use to store pressurized gases or liquids may be secured, for example, well tubulars, pipes, conduits, cylindrical columns, and others, including hollow, solid, and capped end cylinders. Some embodiments disclosed here may lock a cylinder in place without the need for added fixtures, tools, parts or steps other than moving the cylinder 12 into the opening 21. Thus, the cylinder 12 is automatically locked in place upon entry. The clamp 10 may be made out of materials that make the clamp impact resistant and not susceptible to deterioration in hazardous corrosive environments as current devices, chains, straps and cables deteriorate.

Other components may be present that are not described here. The base 18 may be positioned above the arms 14 and 16 in use in some cases if the clamp 10 is used upside down. Clamp 10 may be used in other configurations such as in a vertical orientation mounting a horizontal cylinder 12 for example. Cylinders may be used for welding in a machine shop, on location, or other applications. Cylindrical form containers may also be used in schools, laboratories, welding shops, gas suppliers or any manufacturing or storage facility.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A cylinder clamp, comprising:
a base member having parts that together define an opening for receiving a cylinder;
a first arm and a second arm mounted to the base member at respective pivots, the first arm and the second arm being linked by cooperating surfaces on the first arm and the second arm so that the first arm and the second arm move together between an open position in which a cylinder may be moved into the opening and a closed position in which the first arm and the second arm at least partially encircle an outer circumference of the cylinder; and
a stop member movable between a locked position in which the stop member binds at least the first arm and the base member and an open position in which the stop member is out of binding contact with either or both of the first arm and the base member.

2. The cylinder clamp of claim 1 in which the base member is planar.

3. The cylinder clamp of claim 1 in which the base member has one or more mounts for connecting to an external working surface.

4. The cylinder clamp of claim 1 in which the first arm and second arm do not meet when in the locking position.

5. The cylinder clamp of claim 4 in which the first arm and second arm extend more than two hundred seventy degrees around a cylinder receptacle defined by the first and second arms when in the locked position.

6. The cylinder clamp of claim 1 in which the stop member comprises a pin extended, in the locked position, through an opening in the first arm and an opening in the base member.

7. The cylinder clamp of claim 6 in which the opening in the first arm and the opening in the base member are misaligned in the open position and aligned in the locked position.

8. The cylinder clamp of claim 6 in which the stop member is biased to extend into the opening in the base member.

9. The cylinder clamp of claim 8 in which the stop member comprises a handle to retract the pin from the locked position.

10. The cylinder clamp of claim 6 in which the pin is mounted directly or indirectly on the first arm.

11. (canceled)

12. The cylinder clamp of claim 1 in which, for each of the first arm and the second arm, the pivot is located between a jaw portion and a rear extension, in which the first arm and the second arm are linked by cooperating arcuate toothed surfaces on each of the rear extensions.

13. A combination of the cylinder clamp of claim 1 and a cylinder locked in the locked position within the opening.

14. The combination of claim 13 in which the cylinder contains pressurized gas or liquid.

15. The cylinder clamp of claim 7 in which the stop member bears against the base member when the opening in the first arm and the opening in the base member are misaligned.

16. The cylinder clamp of claim 1 in which the cooperating surfaces on the first arm and the second arm include surfaces that limit opening of the first arm and the second arm.

17. A cylinder clamp, comprising:
a base member having parts that together define an opening for receiving a cylinder;
a first arm and a second arm mounted to the base member at respective pivots, the first arm and the second arm being movable between an open position in which a cylinder may be moved into the opening and a closed position in which the first arm and the second arm at least partially encircle an outer circumference of the cylinder;
a stop member movable between a locked position in which the stop member binds at least the first arm and the base member and an unlocked position in which the stop member is out of binding contact with either or both of the first arm and the base member; and
the stop member comprising a first element within the first arm that cooperates with a second element in the base member.

18. The cylinder claim of claim 17 in which the stop member comprises a pin, the first element comprises a first opening in the first arm and the second element comprises a second opening in the base member and the first element and the second element cooperate through the pin that is extendable through the first opening and the second opening when the first opening and the second opening are aligned.

19. The cylinder clamp of claim 18 in which the first opening and the second opening are misaligned when the first and second arms are in the open position and aligned when the first and second arms are in the closed position.

20. The cylinder clamp of claim 17 in which the stop member is biased to extend into the opening in the base member.

21. The cylinder clamp of claim 18 in which the stop member comprises a handle to retract the pin from the locked position.
